(19) United States
(12) Patent Application Publication
(10) Pub. No.: US 2019/0010033 A1
(43) Pub. Date: Jan. 10, 2019

(54) Nut Housing That Straddles The Gearbox

(71) Applicants: John England, East Lyme, CT (US); Peter Gerard McGonagle, Southport, CT (US); Ryan W. Knapp, Sandy Hook, CT (US)

(72) Inventors: John England, East Lyme, CT (US); Peter Gerard McGonagle, Southport, CT (US); Ryan W. Knapp, Sandy Hook, CT (US)

(21) Appl. No.: 16/029,952

(22) Filed: Jul. 9, 2018

Related U.S. Application Data
(60) Provisional application No. 62/529,642, filed on Jul. 7, 2017.

(51) Int. Cl. B66F 3/44

(52) U.S. Cl. CPC B66F 3/44; B66F 2700/04

(57) ABSTRACT

A lifting apparatus having at least one column. The column includes a drive that rotates a screw, the drive having a first width in a first area, and a nut housing having a support connected to a nut, the nut threaded around the screw such that rotation of the screw moves the nut and support along a first axis. The support including two parallel walls spaced apart a distance larger than the first width such that when the support is positioned at a bottom end of the screw, the two parallel walls fit over the first area. A minimum height of the support is measured from a base of the column to a lowest point of the support. The minimum height is between zero and a width between the two parallel walls.

### FIELD OF THE INVENTION

mon The present invention relates to a nut housing for a lifting motor. More particularly, the improved housing allows for vertical space savings by providing a nut housing that straddles the gearbox/motor.

### BACKGROUND OF THE INVENTION

Lifting devices, such as those used in the railway industry, are often located in pits due to the necessity to provide sufficient power and gearing capabilities below the element to be lifted to enable the lift to align in one position with track level.

However, creation of pits often requires environmental permits, excavation permits, and specialized contractors to create the pit that will hold the lifting device. This results in an inflexible design of the rail yard because lifting devices must often be positioned in fixed locations based on the locations of the pits. Furthermore, pits often create hazards that must be protected to stop people from inadvertently falling into them.

Thus, it is desirable to avoid use of pits where possible to provide increased flexibility at the rail yard and to avoid hazards.

In further embodiments, it may be desirable to eliminate pits all together and utilize portable jack systems such that each jack is on wheels and can be placed independently. However, in such a situation, it is necessary to have the lifting point on the jack very low to or nearly on the ground to enable the jack to lift e.g. a rail car or rail car truck assembly from the appropriate point.

### SUMMARY OF THE INVENTION

Accordingly, it is an object of the present invention to provide a reduced vertical profile lifting apparatus. It is yet another object of the present invention to minimize the distance from the base of the apparatus to the minimum position of the lifting support.

These and other objects of the present invention are achieved by providing a lifting apparatus having at least one column. The at least one column includes a drive that rotates a screw. The drive has a first width in a first area. The column also includes a nut housing having a support connected to a nut. The nut is threaded around the screw such that rotation of the screw moves the nut and support along a first axis. The support includes two parallel walls spaced apart a distance larger than the first width such that when the support is positioned at a bottom end of the screw, the two parallel walls fit over the first area.

In some embodiments, the lifting apparatus further includes at least one roller on at least one of the two parallel walls, and a rail spaced apart from and extending parallel to the screw. The rail is configured to interact with the at least one roller.

In some embodiments, the support further includes a bracket positioned within a width of the screw. The bracket is connected to a plate, which is connected to the nut and the two parallel walls.

In some embodiments, the lifting apparatus further includes at least one roller on each of the two parallel walls, and two rails spaced apart from and extending parallel to the screw. Each of the at least one roller is configured to press against the corresponding one of the two rails upon a force being applied to the bracket in a direction along the first axis to thereby resist rotation of the support about a second axis perpendicular to the first axis.

In some embodiments, the lifting apparatus further includes two rollers on each of the two parallel walls, and two rails spaced apart from and extending parallel to the screw. One of the two rollers is positioned below the nut on one side of one of the two rails and another of the two rollers is positioned above the nut on an opposite side of the one of the two rails.

In some embodiments, the lifting apparatus further includes a minimum height of the support measured from a base of the column to a lower point of the support. The minimum height is between zero and a width between the two parallel walls. In some embodiments, the minimum height is between zero and a thickness of the nut measured along the first axis. In other embodiments, the minimum height is between zero and a thickness of the base measured along the first axis.

In an alternative embodiment of the present invention, a lifting apparatus having at least one column is provided. The at least one column includes a drive that rotates a screw. The drive has a first width in a first area. The column also includes a nut housing having a support connected to a nut. The nut is threaded around the screw such that rotation of the screw moves the nut and support along a first axis. The support includes two parallel walls spaced apart a distance larger than the first width such that when the support is positioned at a bottom end of the screw, the two parallel walls fit over the first area. The support also includes a bracket positioned within a width of the screw. The bracket is connected to a plate, which is connected to the nut and the two parallel walls. The support has a minimum height measured from a base of the column to a lowest point of the support. The minimum height is between zero and a width between the two parallel walls.

In some embodiments, the minimum height is between zero and a thickness of the nut measured along the first axis. In other embodiments, the minimum height is between zero and a thickness of the base of the column measured along the first axis.

In some embodiments, the lifting apparatus further includes at least one roller on at least one of the two parallel walls, and a rail spaced apart from and extending parallel to the screw. The rail is configured to interact with the at least one roller.

In some embodiments, the lifting apparatus further includes at least one roller on each of the two parallel walls, and two rails spaced apart from and extending parallel to the screw. Each of the at least one roller is configured to press against the corresponding one of the two rails upon a force being applied to the bracket in a direction along the first axis to thereby resist rotation of the support about a second axis perpendicular to the first axis.

In some embodiments, the lifting apparatus further includes two rollers on each of the two parallel walls, and two rails spaced apart from and extending parallel to the screw. One of the two rollers is positioned below the nut on one side of one of the two rails and another of the two rollers is positioned above the nut on an opposite side of the one of the two rails.

In another embodiment of the present invention, a lifting device is provided. The lifting device includes a drive that rotates a screw. The drive has a first width in a first area. The lifting device also includes a nut housing having a support connected to a nut. The nut is threaded around the screw such that rotation of the screw moves the nut and support along a first axis. The support includes two parallel walls spaced apart a distance larger than the first width such that when the support is positioned at a bottom end of the screw, the two parallel walls fit over the first area. The support also includes a bracket positioned within a width of the screw. The bracket is connected to a plate, which is connected to the nut and the two parallel walls.

In some embodiments, the lifting device further includes at least one roller on at least one of the two parallel walls, and at least one rail spaced apart from and extending parallel to the screw. The at least one rail is configured to interact with the at least one roller.

In some embodiments, the lifting device further includes a column connected to the lifting device. The column has a base. The support has a minimum height measured from the base to a lowest point of the support.

In some embodiments, the minimum height is between zero and a width between the two parallel walls. In other embodiments, the minimum height is between zero and a thickness of the nut measured along the first axis. In yet other embodiments, the minimum height is between zero and a thickness of the base measured along the first axis.

The invention and its particular features and advantages will become more apparent from the following detailed description considered with reference to the accompanying drawings.

### BRIEF DESCRIPTION OF THE DRAWINGS

FIG. 1 is a partial rear perspective view of a lifting device according to the present invention.

FIG. 2 is a rear perspective view of the lifting device of FIG. 1 installed in a column.

FIG. 3 is a partial rear elevational view of FIG. 2.

FIG. 4 is a partial section view along A-A of FIG. 3.

FIG. 5 is a bottom section view along B-B of FIG. 3.

### DETAILED DESCRIPTION OF THE INVENTION

The present invention is directed to a nut housing for a lifting column designed to lift a load such as a train or train car or parts thereof such as a wheel assembly (rail car truck). A threaded lifting nut is attached to the housing and allows it to traverse up and down along a threaded drive screw. The nut housing straddles around the outside of the gearbox and is able to traverse farther downward along the screw than traditional nut housings, such that the lowest point of vertical travel for the nut housing is defined by the base of the lifting column rather than the height of the gearbox. All structural supports of the nut housing are positioned such that they do not interfere with the gearbox or gearmotor when the nut housing travels to its lowest position.

In preferred embodiments, the nut housing utilizes support rollers with this nuts to minimize the necessary width of the housing. The column has a width larger than the width of the housing with the required clearances between the rollers and the column walls. The vertical spacing between the rollers is determined by the lifting capacity of the jack and the resulting torque on the housing. Preferably, the lifting nut is positioned between the rollers with clearance from the gearbox without interfering with the upper set of rollers.

Referring now to the drawings, wherein like reference numerals designate corresponding structures throughout the views. The following examples are presented to further illustrate and explain the present invention and should not be taken as limiting in any regard.

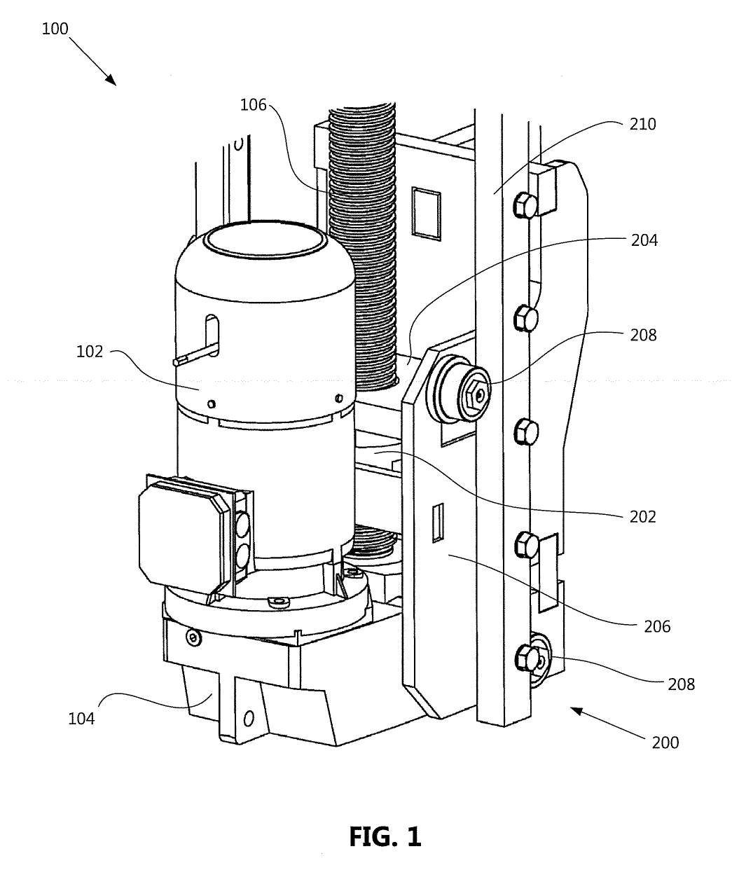

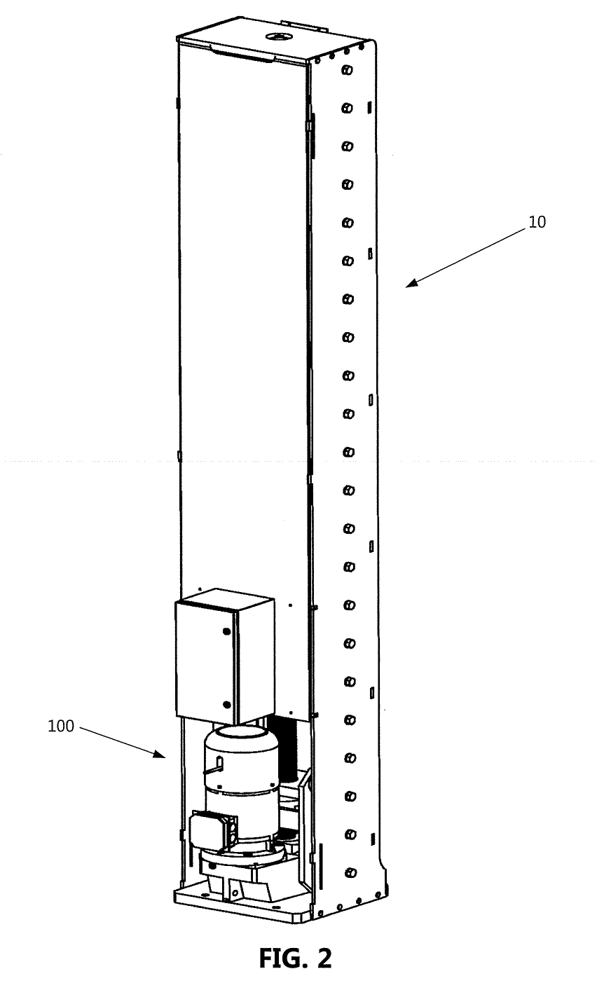

The figures show exemplary embodiments of the present invention. FIG. 1 shows a lifting device 100 having a gearmotor 102 that rotates a lifting screw 106 via a gearbox 104 or other transmission. In certain embodiments, the gearmotor 102 is electrically powered, in other aspects, hydraulics may be used. Lifting device 100 also includes a nut housing 200 having a lifting nut 202 connected to support 204. Lifting nut 202 threads around lifting screw 106. In some embodiments, lifting nut 202 includes an ACME thread pattern. In other embodiments, any other suitable style thread pattern is used. In preferred embodiments, lifting device 100 is connected to a lifting column 10, as depicted in FIG. 2. In some embodiments, lifting column 10 is designed for use as a single mobile jack. In other embodiments, lifting column 10 is part of a larger lifting apparatus. For example, a lifting apparatus may include four lifting columns 10. In certain embodiments multiple separate columns are controlled together but independently placed on wheels or other system which allows the columns to be freely moved around the shop floor for optimal positioning. In other embodiments the columns are connected to a base, which may be configured to move laterally e.g. on wheels and/or on rail tracks. See e.g. U.S. Pat. No. 9,764,933 the content of which is incorporated by reference herein.

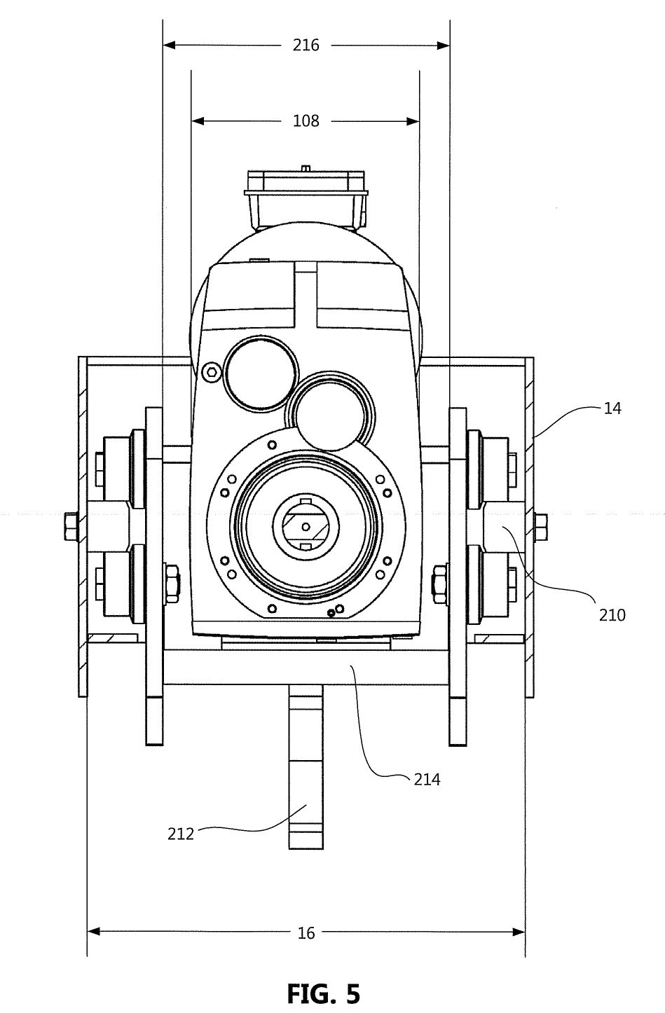

Support 204 is connected on opposite sides to walls 206. In preferred embodiments, walls 206 are parallel to each other and generally extend parallel to the lifting screw 106. Walls 206 are spaced apart a nut housing width 216 between their inner facing surfaces, as depicted in FIG. 5. FIG. 5 also shows gearbox 104 having a width 108. In preferred embodiments, gearbox width 108 is less than nut housing width 216 such that walls 206 fit around gearbox 104 and gearmotor 102 when the nut housing 200 is in its bottom position.

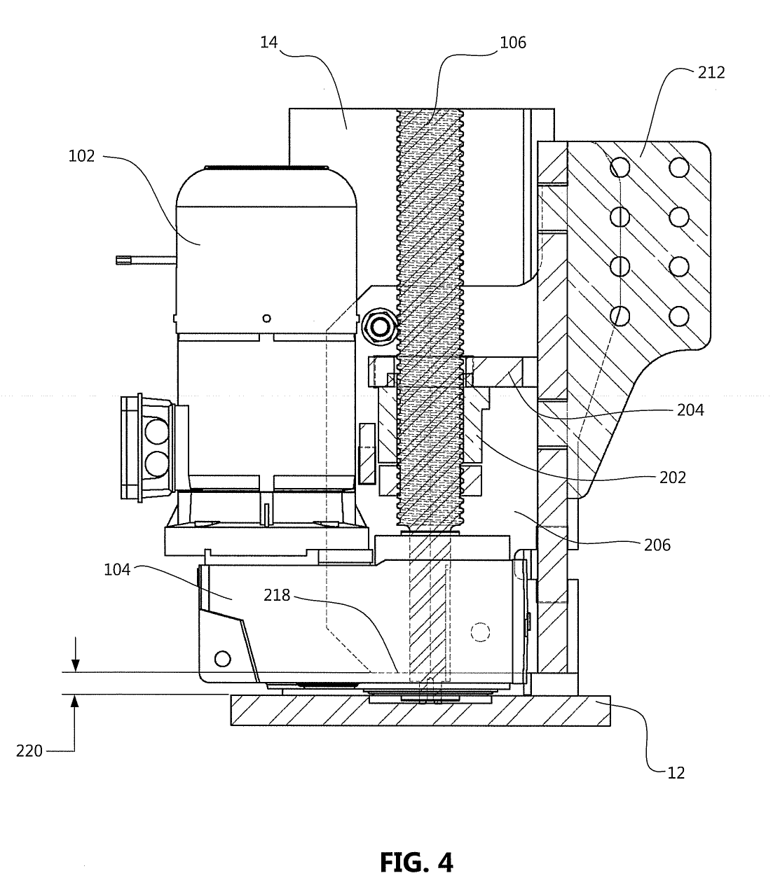

Nut housing 200 also includes lift bracket 212. Preferably, lift bracket 212 is generally aligned along the plane coincident with the central axis of the lifting screw 106 such that the lift bracket 212 and the lifting screw 106 generally align. In some embodiments, lift bracket 212 has a plurality of holes for connecting to external supports or other parts of the lifting apparatus, as depicted in FIG. 4. In preferred embodiments, lift bracket 212 is connected to the support 204 via plate 214. Plate 214 is generally rectangular in shape to keep the walls 206 spaced apart the nut housing width 216 to enable the nut housing 200 to fit over the gearbox 104 and gearmotor 102, as seen in FIG. 5. The lift bracket 212 may be connected to a central support, the central support is connected to other lift brackets 212 of other columns which make up the lifting apparatus, for example, four columns are connected to four corners of a central support which may include a rail section which holds a rail car or part thereof.

In preferred embodiments, walls 206 include rollers 208 that hold nut housing 200 between two lifting rails 210. Lifting rails 210 generally run vertically, extending parallel to the lifting screw 106. In preferred embodiments, lifting rails 210 connect lifting device 100 to column walls 14 of lifting column 10 through any known fastening means, such as nuts and bolts, rivets, or screws, as depicted in FIG. 5. Preferably, lifting column 10 has a width 16 large enough to encompass lifting device 100 with sufficient clearances between the rollers 208 and the column walls 14.

Each roller 208 is configured to press against its corresponding lifting rail 210 to resist rotation of the support 204 about an axis perpendicular to the axis of the lifting screw 106 when a force is applied to the lifting bracket 212 in a direction along the axis of the lifting screw 106. In some embodiments, each wall 206 has one roller 208. In other embodiments, each wall 206 has multiple rollers 208. In other embodiments, only one lifting rail 210 is used and the corresponding wall 206 has at least one roller 208. Preferably, nut housing 200 includes two lifting rails 210 and each wall 206 has two rollers 208 positioned on opposite sides of their respective lifting rail 210, with one roller 208 positioned above lifting nut 202 and the other roller 208 positioned below lifting nut 202, as depicted in FIG. 1.

In preferred embodiments, lifting column 10 has a base 12. Column base 12 can be used to attach the lifting column 10 in a releasable manner, via nuts and bolts and the like, to a foundation or movable base. When nut housing 200 is at its lowest, or bottom, position, it has a minimum height 220 measured from the bottom edge 218 of the nut housing 200 to the top surface of the column base 12, as seen in FIG. 4. In preferred embodiments, minimum height 220 is less than a thickness of the column base 12. In some embodiments, minimum height 220 is less than a thickness of the support 204. In some embodiments, minimum height 220 is in the range between zero and a thickness of the lifting nut 202 measured along the axis of the lifting screw 106. In some embodiments, minimum height 220 is in the range between zero and a width between the walls 206. In other embodiments, minimum height 220 is in the range between zero and a distance between the support 204 and the bottom edge 218 of the nut housing 200.

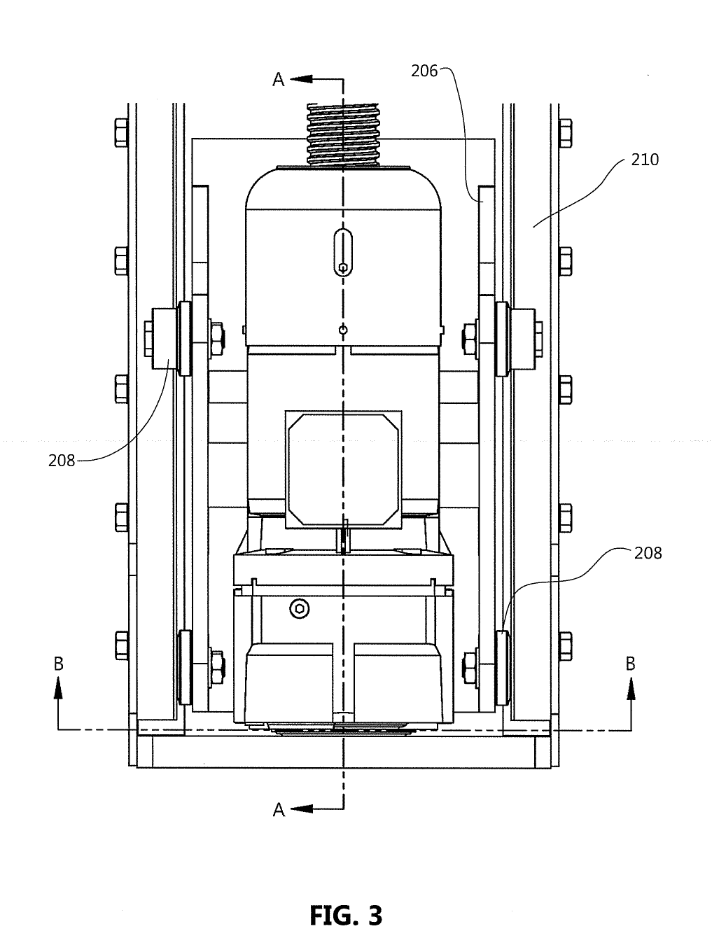

As seen in FIGS. 1, 3, and 4, when the nut housing 200 is at its lowest position, the bottom edge 218 is very close to the bottom of the gearbox 104 because the walls 206 are spaced such that they fit over the gearbox 104 and gearmotor 102. Thus, the present invention reduces the vertical footprint of the overall lifting apparatus and, in many cases, reduces the depth of, or eliminates the need for, a pit to contain the lifting apparatus.

Although the invention has been described with reference to a particular arrangement of parts, features, and the like, these are not intended to exhaust all possible arrangements or features, and indeed many other modifications are variations will be ascertainable to those of skill in the art.

What is claimed is:

1. A lifting apparatus having at least one column, the at least one column comprising:
a drive that rotates a screw, the drive having a first width in a first area, wherein a transmission of the drive is positioned in the first area, the transmission transmitting torque from a motor of the drive to the screw to cause the motor to rotate the screw;
a nut housing having a support connected to a nut, the nut threaded around the screw such that rotation of the screw moves the nut and support along a first axis; and
the support comprising two parallel walls spaced apart a distance larger than the first width such that when the support is positioned at a bottom end of the screw, the two parallel walls fit over the first area and the transmission.

2. The lifting apparatus of claim 1, further comprising:
at least one roller on at least one of the two parallel walls; and
a rail spaced apart from and extending parallel to the screw, the rail configured to interact with the at least one roller.

3. The lifting apparatus of claim 1, wherein the support further comprises:
a bracket positioned within a width of the screw, the bracket connected to a plate, the plate connected to the nut and further connected to the two parallel walls, the plate being perpendicular to the two parallel walls.

4. The lifting apparatus of claim 3, further comprising:
at least one roller on each of the two parallel walls; and
two rails spaced apart from and extending parallel to the screw, each of the at least one roller configured to press against the corresponding one of the two rails upon a force being applied to the bracket in a direction along the first axis to thereby resist rotation of the support about a second axis perpendicular to the first axis.

5. The lifting apparatus of claim 3, further comprising:
two rollers on each of the two parallel walls; and
two rails spaced apart from and extending parallel to the screw, one of the two rollers positioned below the nut on one side of one of the two rails and another of the two rollers positioned above the nut on an opposite side of the one of the two rails.

6. The lifting apparatus of claim 1, further comprising:
a minimum height of the support measured from a base of the column to a lowest point of the support; and
the minimum height being between zero and a width between the two parallel walls.

7. The lifting apparatus of claim 1, further comprising:
a minimum height of the support measured from a base of the column to a lowest point of the support; and
the minimum height being between zero and a thickness of the nut measured along the first axis.

8. The lifting apparatus of claim 1, further comprising:
a minimum height of the support measured from a base of the column to a lowest point of the support; and
the minimum height being between zero and a thickness of the base measured along the first axis.

9. A lifting apparatus having at least one column, the at least one column comprising:
a drive that rotates a screw, the drive having a first width in a first area;
a nut housing having a support connected to a nut, the nut threaded around the screw such that rotation of the screw moves the nut and support along a first axis;
the support comprising:
two parallel walls spaced apart a distance larger than the first width such that when the support is positioned at a bottom end of the screw, the two parallel walls fit over the first area;
a bracket positioned within a width of the screw, the bracket connected to a plate, the plate connected to the nut and further connected to the two parallel walls;
a minimum height of the support measured from a base of the column to a lowest point of the support at a minimum position thereof; and
the minimum height being greater than or equal zero and less than or equal a width between the two parallel walls.

10. The lifting apparatus of claim 9, wherein the minimum height being between zero and a thickness of the nut measured along the first axis.

11. The lifting apparatus of claim 9, wherein the minimum height being between zero and a thickness of the base of the column measured along the first axis.

12. The lifting apparatus of claim 9, further comprising:
at least one roller on at least one of the two parallel walls; and
a rail spaced apart from and extending parallel to the screw, the rail configured to interact with the at least one roller.

13. The lifting apparatus of claim 9, further comprising:
at least one roller on each of the two parallel walls; and
two rails spaced apart from and extending parallel to the screw, each of the at least one roller configured to press against the corresponding one of the two rails upon a force being applied to the bracket in a direction along the first axis to thereby resist rotation of the support about a second axis perpendicular to the first axis.

14. The lifting apparatus of claim 9, further comprising:
two rollers on each of the two parallel walls; and
two rails spaced apart from and extending parallel to the screw, one of the two rollers positioned below the nut on one side of one of the two rails and another of the two rollers positioned above the nut on an opposite side of the one of the two rails.

15. A lifting device comprising:
a drive that rotates a screw, the drive having a first width in a first area;
a nut housing having a support connected to a nut, the nut threaded around the screw such that rotation of the screw moves the nut and support along a first axis;
the support comprising:
two parallel walls spaced apart a distance larger than the first width such that when the support is positioned at a bottom end of the screw, the two parallel walls fit over the first area; and
a bracket positioned within a width of the screw, the bracket connected to a plate, the plate connected to the nut and further connected to the two parallel walls.

16. The lifting device of claim 15, further comprising:
at least one roller on at least one of the two parallel walls; and
at least one rail spaced apart from and extending parallel to the screw, the at least one rail configured to interact with the at least one roller.

17. The lifting device of claim 15, further comprising:
a column connected to the device, the column having a base; and
a minimum height of the support measured from the base to a lowest point of the support.

18. The lifting device of claim 17, wherein the minimum height being between zero and a width between the two parallel walls.

19. The lifting device of claim 17, wherein the minimum height being between zero and a thickness of the nut measured along the first axis.

20. The lifting device of claim 17, wherein the minimum height being between zero and a thickness of the base measured along the first axis.
